(19) United States
(12) Patent Application Publication
(10) Pub. No.: US 2023/0031424 A1
(43) Pub. Date: Feb. 2, 2023

(54) BIODEGRADABLE COMPOSITION, BIODEGRADABLE WRAP FILM AND MANUFACTURING METHOD THEREOF

(71) Applicant: NAN YA PLASTICS CORPORATION, TAIPEI (TW)

(72) Inventors: TE-CHAO LIAO, TAIPEI (TW); CHING-YAO YUAN, TAIPEI (TW)

(21) Appl. No.: 17/746,867

(22) Filed: May 17, 2022

(30) Foreign Application Priority Data
Jul. 21, 2021 (TW) 110126718

(51) Int. Cl. C08L 67/02; C08L 23/06; C08L 23/12; C08L 27/06; C08L 67/04; C08K 5/00; C08J 5/22; C08J 3/22; B32B 27/08

(52) U.S. Cl. CPC C08L 67/02; C08L 23/06; C08L 23/12; C08L 27/06; C08L 67/04; C08K 5/0033; C08J 5/2218; C08J 3/22; B32B 27/08; C08L 2201/06; B32B 2250/03; B32B 2250/24; B32B 2307/7163; B32B 2439/70; B32B 2323/04; B32B 2323/10; B32B 2327/06; B32B 2367/00

(57) ABSTRACT

A biodegradable composition, a biodegradable wrap film and a manufacturing method thereof are provided. The biodegradable wrap film includes an inner layer, at least one interlayer formed on the inner layer, and an outer layer formed on the interlayer. The inner layer, the at least one interlayer formed on the inner layer, and the outer layer are respectively formed by the biodegradable composition. The biodegradable composition includes 50 to 98.9 wt % of a polyolefin resin, 1 to 49.9 wt % of a biodegradable polymer and 0.1 to 5 wt % of an organic degradation aid.

### CROSS-REFERENCE TO RELATED PATENT APPLICATION

This application claims the benefit of priority to Taiwan Patent Application No. 110126718, filed on Jul. 21, 2021. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a degradable composition, and more particularly to a biodegradable composition, a biodegradable wrap film and a manufacturing method thereof.

### BACKGROUND OF THE DISCLOSURE

Wrap films are a type of plastic packaging products mainly used in situations such as for food preservation in refrigerators, heating food by microwave and packaging of fresh and cooked foods. As an essential packaging material for food preservation in people's daily lives, the wrap films are widely used in the field of food packaging such as at supermarkets, in households, and in industrial manufacturing, and the functionalities of such wrap films is attracting increasing attention from the public.

Conventionally, wrap films are mostly made from polyvinyl chloride (PVC) or polyethylene (PE). The polyvinyl chloride and the polyethylene are unlikely to be degraded in a natural environment, thereby causing environmental issues. At present, a few commercially available wrap films have photosensitive accelerators added therein, and the photosensitive accelerators are enabled by ultraviolet to promote a cracking reaction of plastics. However, if a wrap film having a photosensitive accelerator is placed in an environment without sunlight, a cracking reaction is not carried out.

Therefore, how to promote an effective natural degradation of a wrap film through compositional improvement of a plastic composition to overcome the aforementioned issues has become one of the important issues to be solved in the related art.

### SUMMARY OF THE DISCLOSURE

In response to the above-referenced technical inadequacy, the present disclosure provides a biodegradable composition, a biodegradable wrap film and a manufacturing method thereof. The biodegradable composition and the biodegradable wrap film have a biodegradable property, thereby improving the issue of environmental pollution caused by existing disposable plastics.

In one aspect, the present disclosure provides a biodegradable composition. The biodegradable composition includes 50 to 98.9 wt % of a polyolefin resin, 1 to 49.9 wt % of a biodegradable polymer and 0.1 to 5 wt % of an organic degradation aid.

In another aspect, the present disclosure provides a biodegradable wrap film. The biodegradable wrap film includes an inner layer, at least one interlayer and an outer layer. The at least one interlayer is formed on the inner layer, and the outer layer is formed on the at least one interlayer. The inner layer, the at least one interlayer and the outer layer are respectively formed by a biodegradable composition; and the biodegradable composition includes 50 to 98.9 wt % of a polyolefin resin, 1 to 49.9 wt % of a biodegradable polymer and 0.1 to 5 wt % of an organic degradation aid.

In yet another aspect, the present disclosure provides a manufacturing method of a biodegradable wrap film including the following steps: first, providing a resin composition that includes a biodegradable composition, in which based on 100 wt % of the biodegradable polymer, the biodegradable composition includes 50 to 98.9 wt % of a polyolefin resin, 1 to 49.9 wt % of a biodegradable polymer and 0.1 to 5 wt % of an organic degradation aid; next, preparing the resin composition into a plurality of plastic masterbatches; and finally, forming at least one resin layer using the plurality of plastic masterbatches.

In an embodiment of the present disclosure, the biodegradable composition further includes 1 to 10 wt % of a processing aid.

In an embodiment of the present disclosure, the polyolefin resin is selected from a group consisting of polyvinyl chloride (PVC), polyethylene (PE), polypropylene (PP) and a polyolefin elastomer (POE).

In an embodiment of the present disclosure, the biodegradable polymer is selected from a group consisting of polylactic acid (PLA), polyhydroxyalkanoates (PHAs), poly(butylene succinate) (PBS), polycaprolactone (PCL), poly(butylene adipate-co-terephthalate) (PBAT) and polyvinyl alcohol (PVA).

In an embodiment of the present disclosure, the organic degradation aid is selected from a group consisting of lactose, galactose, succinate, malate, aspartate and a furanone derivative.

One beneficial effect of the present disclosure is that, the degradable composition and the biodegradable wrap film provided by the present disclosure can have a biodegradable property through a technical solution of “the biodegradable composition including 1 to 49.9 wt % of a biodegradable polymer and 0.1 to 5 wt % of an organic degradation aid,” so as to improve on the existing issue of environmental pollution caused by disposable plastics.

Furthermore, the degradable polymer that has a biodegradable ability can be a polymer prepared from renewable natural resources such as microorganisms, animals and plants. The biodegradable polymer has the physical properties of conventional plastics, can replace conventional petroleum-based plastics, and is more environmentally friendly than the conventional plastics.

It should be noted that the organic degradation aid has an effect of attracting microorganisms in the natural environment, thereby facilitating a faster degradation of the biodegradable composition by the microorganisms.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic cross-sectional view of a biodegradable wrap film according to a second embodiment of the present disclosure;

FIG. 2 is a flowchart of a manufacturing method of a biodegradable wrap film according to a third embodiment of the present disclosure; and

FIG. 3 is a chart of the experimental results of degradation of a biodegradable wrap film in seawater according to the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

### First Embodiment

A first embodiment of the present disclosure provides a biodegradable composition. The biodegradable composition includes 50 to 98.9 wt % of a polyolefin resin, 1 to 49.9 wt % of a biodegradable polymer and 0.1 to 5 wt % of an organic degradation aid.

Further, the polyolefin resin is selected from a group consisting of polyvinyl chloride (PVC), polyethylene (PE), polypropylene (PP) and a polyolefin elastomer (POE). Preferably, the polyolefin resin is polyvinyl chloride or polyethylene. It should be noted that, when the content of the polyolefin resin is lower than 50 wt %, the plasticity of the biodegradable composition is decreased, causing inconvenience in subsequent processing procedures. Preferably, the content of the polyolefin resin can be 70 to 85 wt %. However, such details serve to describe only some feasible implementations provided by this embodiment, and the present disclosure is not limited thereto.

The biodegradable polymer is selected from a group consisting of polylactic acid (PLA), polyhydroxyalkanoates (PHA), poly(butylene succinate) (PBS), polycaprolactone (PCL), poly(butylene adipate-co-terephthalate) (PBAT) and polyvinyl alcohol (PVA); and preferably, the biodegradable polymer is polylactic acid, poly(butylene adipate-co-terephthalate) or polyvinyl alcohol. It is worth mentioning that the degradable polymer that has a biodegradable ability can be a polymer prepared from renewable natural resources such as microorganisms, animals and plants. For example, the polylactic acid is a polymer synthesized using natural grain crops as raw materials. The biodegradable polymer has the physical properties of conventional plastics, can replace conventional petroleum-based plastics, and is more environmentally friendly than the conventional plastics.

It should be noted that, when the content of the biodegradable polymer is lower than 50 wt %, the plasticity and toughness of the biodegradable composition is decreased. Preferably, the content of the biodegradable polymer can be 15 to 30 wt %. However, such details serve to describe only some feasible implementations provided by this embodiment, and the present disclosure is not limited thereto.

Particularly, the organic degradation aid has an effect of attracting microorganisms in the natural environment, thereby facilitating a faster degradation of the biodegradable composition by the microorganisms. In some embodiments of the present disclosure, the organic degradation aid is selected from a group consisting of lactose, galactose, succinate, malate, aspartate and a furanone derivative.

It should be noted that, since the organic degradation aid has an effect of attracting microorganisms in the natural environment, the content of the organic degradation aid cannot be higher than 5 wt %. If the content of the organic degradation aid is higher than 5 wt %, a wrap film prepared from the biodegradable composition is very likely to trigger the growth of bacteria in actual use. Preferably, the content of the organic degradation aid can be 0.5 wt %, 1 wt %, 1.5 wt %, 2 wt %, 2.5 wt %, 3 wt %, 3.5 wt %, 4 wt %, 4.5 wt % and 5 wt %. However, such details serve to describe only some feasible implementations provided by this embodiment, and the present disclosure is not limited thereto.

In some embodiments of the present disclosure, the biodegradable composition can further include 1 to 10 wt % of a processing aid. It should be noted that, the processing aid can effectively lower a mechanical torsion in melt extrusion of a polyester raw material, reducing the breakage of polymer molecular chains. Further, the processing aid can be pentaerythritol stearate (PETS) or the like, and has good thermal stability, low volatility and good releasing and flowing properties at a high temperature. However, such details serve to describe only some feasible implementations provided by this embodiment, and the present disclosure is not limited thereto.

### Second Embodiment

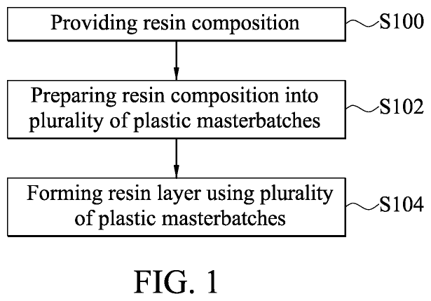

Referring to FIG. 1, a second embodiment of the present disclosure provides a manufacturing method of a biodegradable wrap film including steps set forth below.

First, in step S100, a resin polymer is provided. For example, the resin polymer of the present invention can include a biodegradable composition. Based on 100 wt % of the biodegradable polymer, the biodegradable composition includes: 50 to 98.9 wt % of a polyolefin resin, 1 to 49.9 wt % of a biodegradable polymer and 0.1 to 5 wt % of an organic degradation aid. In this embodiment, the resin polymer can include the biodegradable composition of the first embodiment of the present disclosure.

Next, in step S102, the resin composition is prepared into a plurality of plastic masterbatches. That is to say, the resin composition can be prepared into a plurality of plastic masterbatches using an extruder or other similar apparatuses.

Finally, in step S104, at least one resin layer is formed by using the plurality of plastic masterbatches. For example, the plurality of masterbatches can be prepared into at least one resin layer by a plastic film apparatus of a film blowing technology or a film casting processing technology. However, the aforementioned embodiment is only one feasible embodiment, and the present disclosure is not limited thereto. Preferably, the number of the resin layers is three or more.

### Third Embodiment

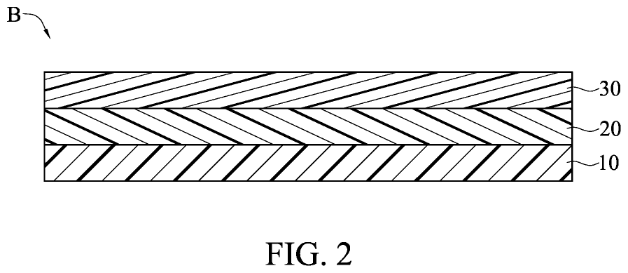

Referring to FIG. 2, a third embodiment of the present disclosure provides a biodegradable wrap film B. The biodegradable wrap film B can include an inner layer 10, at least one interlayer 20 and an outer layer 30. The at least one interlayer 20 is formed on the inner layer 10, and the outer layer 30 is formed on the at least one interlayer 20. In this embodiment, the inner layer 10, the at least one interlayer 20 and the outer layer 30 are respectively formed by the biodegradable composition of the first embodiment of the present disclosure.

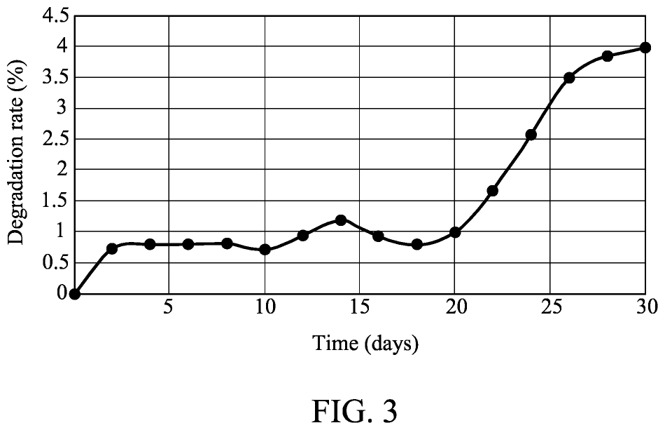

Further, the biodegradable wrap film B can be a structure that has three or more layers, and a thickness of the biodegradable wrap film B can be 5 to 30 μm. In some embodiments of the present disclosure, the three-layer structure of the biodegradable wrap film B can be an A/B/A three-layer structure as shown in FIG. 3, with A representing the inner layer 10 and the outer layer 30, and B representing the interlayer 20. In some embodiments of the present disclosure, the composition of the biodegradable composition of layer A and layer B can be the same or different. However, these details serve to describe only some feasible implementations provided by this embodiment, and the present disclosure is not limited thereto.

Referring to Table 1, several specific experimental examples as well as property evaluation of the biodegradable wrap film of the present disclosure are provided as below.

Experimental example 1: in the layer A composition of the experimental example 1, the polyolefin resin is PE, and the content of the polyolefin resin is 50 wt %. The biodegradable polymers are polylactic acid (PLA) and poly(butylene adipate-co-terephthalate) (PBAT), and the content of the biodegradable polymers is 45 wt %. The organic degradation aids are galactose and succinate, and the content of the organic decomposition aids is 5 wt %. In the layer B composition of the experimental example 1, the polyolefin resin is PE, and the content of the polyolefin resin is 50 wt %. The biodegradable polymer is polylactic acid, and the content of the biodegradable polymer is 44 wt %. The organic degradation aids are galactose and succinate, and the content of the organic decomposition aids is 1 wt %. The processing aid is an anti-fogging agent with a content of 5 wt %. It should be noted that the processing aid is added to the layer B (interlayer) and can be prevented from contacting with the outside, such that the functions of the processing aid can be maintained.

In the test results of the experimental example 1, the MD tensile strength is 760 kg/cm², and the TD tensile strength is 380 kg/cm². The MD elongation is 370%, and the TD elongation is 920%. The haze is 1.8%, the gloss is 133%, the stickiness is 4.1 g/30 mm, and the anti-fogging property is good.

Experimental example 2: in the layer A composition of the experimental example 2, the polyolefin resin is PE, and the content of the polyolefin resin is 90 wt %. The biodegradable polymers are polylactic acid (PLA) and poly(butylene adipate-co-terephthalate) (PBAT), and the content of the biodegradable polymers is 8 wt %. The organic degradation aids are galactose and succinate, and the content of the organic decomposition aids is 2 wt %. In the layer B composition of the experimental example 2, the polyolefin resin is PE, and the content of the polyolefin resin is 90 wt %. The biodegradable polymer is polylactic acid, and the content of the biodegradable polymer is 4 wt %. The organic degradation aids are galactose and succinate, and the content of the organic decomposition aids is 1 wt %. The processing aid is an anti-fogging agent with a content of 5 wt %. It should be noted that the processing aid is added to the layer B (interlayer) and can be prevented from contacting with the outside, such that the functions of the processing aid can be maintained.

In the test results of the experimental example 2, the MD tensile strength is 830 kg/cm², and the TD tensile strength is 420 kg/cm². The MD elongation is 435%, and the TD elongation is 810%. The haze is 1.5%, the gloss is 142%, the stickiness is 3.8 g/30 mm, and the anti-fogging property is good.

Comparative example 1: in the layer A composition of the comparative example 1, the polyolefin resin is PE, and the content of the polyolefin resin is 100 wt %. The layer A composition of the comparative example 1 does not include a biodegradable polymer or an organic degradation aid. In the layer B composition of the comparative example 1, the polyolefin resin is PE, and the content of the polyolefin resin is 99 wt %. The biodegradable polymer is polylactic acid, and the content of the biodegradable polymer is 4 wt %. The organic degradation aids are galactose and succinate, and the content of the organic decomposition aids is 1 wt %. The processing aid is an anti-fogging agent with a content of 1 wt %.

In the test results of the comparative example 1, the MD tensile strength is 710 kg/cm², and the TD tensile strength is 370 kg/cm². The MD elongation is 410%, and the TD elongation is 780%. The haze is 1.3%, the gloss is 149%, the stickiness is 3.5 g/30 mm, and the anti-fogging property is good.

It can be known from the foregoing results that the biodegradable wrap films of the experimental example 1 and the experimental example 2 both have better MD tensile strength, TD tensile strength, TD elongation, haze and stickiness than that of the wrap film of the comparative example 1. From a comparison of the three, the biodegradable wrap film of the experimental example 2 has the most adequate physical properties.

TABLE 1

| | | Experi- | Experi- | Compara- |
|---|---|---|---|---|
| | | mental | mental | tive |
| Item | | example 1 | example 2 | example 1 |
| Wrap | Total thickness (μm) | 30 | 20 | 20 |
| film | Co-extrusion structure | A/B/A | A/B/A | A/B/A |
| | Thickness of each | 5/20/5 | 3/14/3 | 3/14/3 |
| | layer (μm) | | | |
| Layer A | Polyolefin resin | PE | PE | PE |
| Compo- | Content of polyolefin | 50 | 90 | 100 |
| sition | resin (wt %) | | | |
| and | Biodegradable | PLA/PBAT | PLA/PBAT | — |
| amount | polymer (s) | | | |
| | Content of | 45 | 8 | — |
| | biodegradable | | | |
| | polymer (s) (wt %) | | | |
| | Organic degradation | Galactose + | Galactose + | — |
| | aid (s) | Succinate | Succinate | |
| | Content of organic | 5 | 2 | — |
| | degradation aid (s) | | | |
| | (wt %) | | | |
| | Processing aid | — | — | — |
| | Content of processing | — | — | — |
| | aid (wt %) | | | |
| Layer B | Polyolefin resin | PE | PE | PE |
| Compo- | Content of polyolefin | 50 | 90 | 99 |
| sition | resin (wt %) | | | |
| and | Biodegradable | PLA | PLA | — |
| amount | polymer (s) | | | |
| | Content of | 44 | 4 | — |
| | biodegradable | | | |
| | polymer (s) (wt %) | | | |
| | Organic degradation | Galactose + | Galactose + | — |
| | aid (s) | Succinate | Succinate | |
| | Content of organic | 1 | 1 | — |
| | degradation aid (s) | | | |
| | (wt %) | | | |
| | Processing aid | Anti- | Anti- | Anti- |
| | | fogging | fogging | fogging |
| | | agent | agent | agent |
| | Content of processing | 5 | 5 | 1 |
| | aid (wt %) | | | |
| Physical | MD tensile strength | 760 | 830 | 710 |
| properties | (kg/cm²) | | | |
| of wrap | TD tensile strength | 380 | 420 | 370 |
| film | (kg/cm²) | | | |
| | MD elongation (%) | 370 | 435 | 410 |
| | TD elongation (%) | 920 | 810 | 780 |
| | Haze (%) | 1.8 | 1.5 | 1.3 |
| | Gloss (%) | 133 | 142 | 149 |
| | Stickiness (g/30 mm) | 4.1 | 3.8 | 3.5 |
| | Anti-fogging property | Yes | Yes | Yes |
| | (No fogging at 90° C.) | | | |

[Degradation Test]

In the experimental example 1, the degradation rate of the biodegradable wrap film in seawater is tested, and this test is carried out by leaving the biodegradable wrap film of the experimental example 1 in seawater for 30 days.

Referring to Table 2 and FIG. 3, the biodegradable wrap film of the present disclosure can be degraded in seawater.

TABLE 2

| Time | Degradation rate (%) |
|---|---|
| 2 days | 0.73 |
| 4 days | 0.8 |
| 6 days | 0.8 |
| 8 days | 0.82 |
| 10 days | 0.72 |
| 12 days | 0.94 |
| 14 days | 1.18 |
| 16 days | 0.93 |
| 18 days | 0.8 |
| 20 days | 0.99 |
| 22 days | 1.65 |
| 24 days | 2.57 |
| 26 days | 3.5 |
| 28 days | 3.85 |
| 30 days | 3.97 |

[Beneficial Effects of the Embodiments]

One beneficial effect of the present disclosure is that, the degradable composition and the biodegradable wrap film provided by the present disclosure can have a biodegradable property through a technical solution of “the biodegradable composition including 1 to 49.9 wt % of a biodegradable polymer and 0.1 to 5 wt % of an organic degradation aid,” so as to improve on the existing issue of environmental pollution caused by disposable plastics.

Furthermore, the degradable polymer that has a biodegradable ability can be a polymer prepared from renewable natural resources such as microorganisms, animals and plants. The biodegradable polymer has the physical properties of conventional plastics, can replace conventional petroleum-based plastics, and is more environmentally friendly than the conventional plastics.

It should be noted that, the organic degradation aid has an effect of attracting microorganisms in the natural environment, thereby facilitating a faster degradation of the biodegradable composition by the microorganisms.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A biodegradable composition, comprising:
50 to 98.9 wt % of a polyolefin resin;
1 to 49.9 wt % of a biodegradable polymer; and
0.1 to 5 wt % of an organic degradation aid.

2. The biodegradable composition of claim 1, further comprising: 1 to 10 wt % of a processing aid.

3. The biodegradable composition of claim 1, wherein the polyolefin resin is selected from a group consisting of polyvinyl chloride, polyethylene, polypropylene and a polyolefin elastomer.

4. The biodegradable composition of claim 1, wherein the biodegradable polymer is selected from a group consisting of polylactic acid, polyhydroxyalkanoates, poly(butylene succinate), polycaprolactone, poly(butylene adipate-co-terephthalate) and polyvinyl alcohol.

5. The biodegradable composition of claim 1, wherein the organic degradation aid is selected from a group consisting of lactose, galactose, succinate, malate, aspartate and a furanone derivative.

6. A biodegradable wrap film, comprising:
an inner layer;
at least one interlayer formed on the inner layer; and
an outer layer formed on the interlayer;
wherein the inner layer, the at least one interlayer and the outer layer are respectively formed by a biodegradable composition; and the biodegradable composition comprises:
50 to 98.9 wt % of a polyolefin resin;
1 to 49.9 wt % of a biodegradable polymer; and
0.1 to 5 wt % of an organic degradation aid.

7. The biodegradable wrap film of claim 6, wherein the biodegradable composition further comprises: 1 to 10 wt % of a processing aid.

8. The biodegradable wrap film of claim 6, wherein the polyolefin resin is selected from a group consisting of polyvinyl chloride, polyethylene, polypropylene and a polyolefin elastomer.

9. The biodegradable wrap film of claim 6, wherein the biodegradable polymer is selected from a group consisting of polylactic acid, polyhydroxyalkanoates, poly(butylene succinate), polycaprolactone, poly(butylene adipate-co-terephthalate) and polyvinyl alcohol.

10. The biodegradable wrap film of claim 6, wherein the organic degradation aid is selected from a group consisting of lactose, galactose, succinate, malate, aspartate and a furanone derivative.

11. A manufacturing method of a biodegradable wrap film, comprising the following steps:
providing a resin composition comprising a biodegradable composition, wherein based on 100 wt % of the biodegradable composition, the biodegradable composition comprises:
50 to 98.9 wt % of a polyolefin resin;
1 to 49.9 wt % of a biodegradable polymer; and
0.1 to 5 wt % of an organic degradation aid;
preparing the resin composition into a plurality of plastic masterbatches; and
forming at least one resin layer using the plurality of plastic masterbatches.

12. The manufacturing method of a biodegradable wrap film of claim 11, wherein the biodegradable composition further comprises: 1 to 10 wt % of a processing aid.

13. The manufacturing method of a biodegradable wrap film of claim 11, wherein the polyolefin resin is selected from a group consisting of polyvinyl chloride, polyethylene, polypropylene and a polyolefin elastomer.

14. The manufacturing method of a biodegradable wrap film of claim 11, wherein the biodegradable polymer is selected from a group consisting of polylactic acid, polyhydroxyalkanoates, poly(butylene succinate), polycaprolactone, poly(butylene adipate-co-terephthalate) and polyvinyl alcohol.

15. The manufacturing method of a biodegradable wrap film of claim 11, wherein the organic degradation aid is selected from a group consisting of lactose, galactose, succinate, malate, aspartate and a furanone derivative.
